(19) United States
(12) Patent Application Publication
(10) Pub. No.: US 2004/0144611 A1
(43) Pub. Date: Jul. 29, 2004

(54) Eddy current clutch as well as fan coupling with eddy current clutch

(76) Inventors: Andreas Wolf, Tettnang (DE); Ricardo Manuel Turksch, Salem (DE)

Correspondence Address: William D. Breneman. Esq., BRENEMAN & GEORGES, 3150 Commonwealth Ave, Alexandria, VA, 22305, US

(21) Appl. No.: 10/740,401

(22) Filed: Dec. 22, 2003

(30) Foreign Application Priority Data
Dec. 23, 2002 (DE) 102 61 567.5
Jan. 28, 2003 (DE) 103 03 183.9

(51) Int. Cl. F16D 27/12

(52) U.S. Cl. 192/48.2; 192/84.2

(57) ABSTRACT

An eddy current coupling (4) is proposed, with a first movable coupling element (13) comprising an electrically conductive eddy current portion (16), in which eddy currents can form. Furthermore, the eddy current coupling has a second coupling element (10) which is movable relative to the first coupling element (13) and on which magnets (14) are arranged in such a way that, in the event of a relative movement of the first and second coupling elements (10, 13) with respect to one another, the magnets are led past the eddy current portion (16). The first and the second coupling element (10, 13) are separated at the eddy current portion (16) via an air gap (18). Magnetic conduction means (17, 17a) consisting of magnetically conductive material are provided in the eddy current portion (16). According to the invention, in a plurality of first regions (17a), the area of which is not inconsiderable as compared with the eddy current portion (16), the magnetic conduction means (17, 17a) are led in the direction of the air gap (18). However, as also seen from the air gap (18), the magnetic conduction means extend between the first regions (17a) in the eddy current portion (16), at points lying at a lower level, over further second regions.

The invention relates to an eddy current coupling according to the preamble of claim 1 and to a fan coupling with such an eddy current coupling.

### PRIOR ART

European patent specification EP 0 634 568 D1 discloses a friction-type shift coupling for a fan wheel of a motor vehicle internal combustion engine, in which the fan wheel is directly connected to a drive shaft via a first friction disk coupling for the direct transmission of the engine rotational speed and, with the friction disk coupling cut out, the fan wheel is pulled along by means a second coupling in the form of an eddy current coupling. The eddy current coupling comprises two annular regions located opposite one another, on one side, a magnetic disk wheel with permanent magnets and, on the opposite side, a flat circular copper ring which is arranged on a flat circular steel ring. The magnetic field of the eddy currents is reinforced by the steel ring, thereby improving the effectiveness of the eddy current coupling.

### OBJECTING AND ADVANTAGES OF THE INVENTION

The object on which the invention is based is to achieve a comparatively improved effectiveness in terms of torque transmission in systems with an eddy current coupling.

This object is achieved by means of the features of claims 1 and 8.

The subclaims describe advantageous and expedient developments of the invention.

The invention proceeds from an eddy current coupling for, in particular, an assembly of an internal combustion engine, for example for a fan wheel in a fan or for a water pump, with a first movable coupling element comprising an electrically conductive eddy current portion, in which eddy currents can form, and with a second coupling element which is movable relative to the first coupling element and on which magnets, in particular permanent magnets, are arranged in such a way that, in the event of a relative movement of the first and second coupling elements with respect to one another, the magnets are led past the eddy current portions, the first and second coupling element being separated at the eddy current portion via an air gap, and magnetic conduction means consisting of magnetically conductive material being provided in the eddy current portion. The essence of the invention, then, is that, for an appreciable improvement in the feeding of the magnetic field of induced eddy currents into the field of the magnets in a plurality of first regions, the area of which is not inconsiderable as compared with the magnet-facing area of the eddy current portion, the magnetic conduction means are led in terms of their plane in the direction of the air gap, but, as also seen from the air gap, extend between the first regions in the eddy current portion, at points lying at a lower level, over further second regions. The magnets should likewise be moved past over these regions. The area of the first regions should preferably amount to no less than 20% of the area of the eddy current portion, in order to achieve a detectable improved feed of the magnetic field of induced eddy currents.

Advantageously, at least some of the magnetic conduction means, preferably all the magnetic conduction means, of the first regions are connected, free of gaps, to the magnetic conduction means of the second regions, in order to achieve as good a magnetic feed as possible. Advantageously, the first regions extend at least approximately over the complete width of the elongate eddy current portion.

In a preferred embodiment of the invention, the first and second coupling elements are rotatably mounted, preferably essentially rotationally symmetrical bodies, in which the eddy current portion and also the magnets are formed in each case in an annular region, the annular regions being located opposite one another. It is also possible for eddy current portions and portions with magnets to alternate in the annular regions.

In a preferred embodiment of the invention, particularly in the case of annular magnetic and eddy current regions, the first regions are elongate and extend radially.

The first regions in this case preferably succeed one another so closely that the second regions are likewise of elongate and radial design.

In order to obtain an optimization of the magnetic feed of the magnetic field of induced eddy currents, it is proposed, furthermore, that the magnetic conduction means be led as far as the air gap at least in some of the first regions. Advantageously, the magnetic conduction means are led directly up to the air gap in all the first regions. In this way, an interaction between the field of the magnet and the field of the induced alternating currents which is concentrated in the magnetic conduction means is interrupted merely by a narrow air gap. That is to say, the routing of the magnetic field in material which is not magnetically conductive is reduced merely to the air gap.

As compared with a conventional eddy current coupling, by means of the procedure according to the invention, assuming a corresponding dimensioning of the first and second regions, up to three times higher torque transmission can readily be achieved, with the magnetic energy of the magnets used being the same.

Furthermore, it is preferable if the magnetic conduction means comprise a sheetlike circular ring, in which preferably equally spaced-apart elevations are arranged on a surface. The elevations may be rectangular in cross section and be configured as radial webs, the length of which preferably corresponds to the width of the circular ring. The webs may be dimensioned in terms of their height, that is to say they are dimensioned perpendicularly to the circular ring surface, in such a way that they reach as far as the air gap.

In an embodiment which is also preferred, a magnetic conduction means configured in this way, for example as a steel ring, is cast into the eddy current portion which consists, for example, of aluminum. Elevations of the magnetic conduction means can thereby be configured in a comparatively simple way so as to be flush with the surface of the eddy current portion.

The eddy current coupling described can preferably be used in fan couplings for the fan of an internal combustion engine or of a water pump, in combination with one or more electromagnetically actuable friction disk couplings.

### DRAWINGS

An exemplary embodiment of the invention is illustrated in the drawings and is explained in more detail, with further advantages and particulars being specified. In the drawings:

FIG. 1 shows a detail of a fan coupling in a partial sectional side view, the section being taken through the center line of the drive shaft,

FIG. 2 shows a perspective illustration of an annular eddy current disk with cast-in magnetic conduction means, and

FIG. 3 shows the magnetic conduction means alone, likewise in a perspective view.

### DESCRIPTION OF THE EXEMPLARY EMBODIMENT

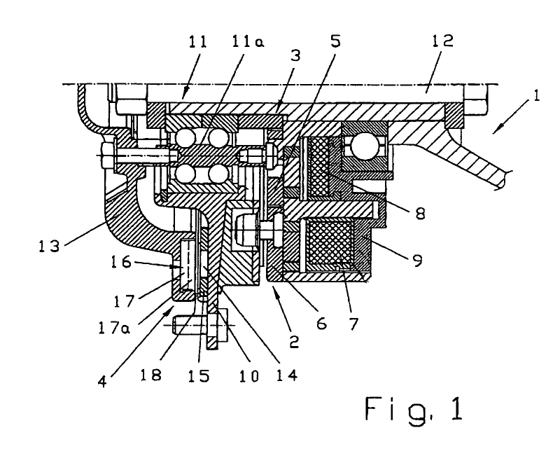

FIG. 1 illustrates a two-stage fan coupling 1. The fan coupling 1 comprises two electromagnetically actuable friction disk couplings 2, 3 and an eddy current coupling 4.

The annular armature disks 5, 6 of the friction disk couplings 2, 3 are moved by electromagnets 7, 8 which are arranged in a stationary stator 9.

In the event that both friction disk couplings 2, 3 are out of engagement, a flange 10 of a fan wheel is driven solely by moments of friction of a ball bearing arrangement 11, insofar as a drive shaft 12 is rotating. With the friction disk coupling 3 in engagement, the rotation of the drive shaft 12 is transmitted to a middle ring 11a of the ball bearing arrangement 11, on which middle ring a cooling ring 13 is arranged fixedly. In the radially outer region of the latter is located the eddy current coupling. The flange 10 of the fan wheel is pulled along by the eddy current coupling.

With the friction disk coupling 3 in engagement, the flange 10 of the fan wheel is driven directly.

The eddy current coupling 4 is constructed as follows:

In an annular region, permanent magnets 14 are arranged in a circumferential direction on the flange 10 and have alternating polarity (north/south) in the circumferential direction. The permanent magnets 14 are fixed in their position by means of a spacer ring 15.

With the cooling ring 13 rotating, the magnetic fields of the permanent magnets 14 induce eddy currents in an eddy current region 16 of the cooling ring 13. These eddy currents, in turn, generate a magnetic field which comes into interaction with the magnetic field of the permanent magnets 14 and counteracts this magnetic field in such a way that a rotation of the cooling ring 3 likewise sets the flange 10 in rotation.

Normally, the eddy current region 16 is constructed in the form of an electrically highly conductive annular disk (for example, made from copper) which is arranged on an annular steel disk. The annular steel disk improves the formation of the magnetic field of the eddy currents induced by the permanent magnets.

This is where the invention comes in, in that an annular steel disk 17, as magnetic conduction means, is provided with webs 17a which reach up to an air gap 18 between the cooling ring 13 and the flange 10. The likewise web-shaped interspaces 19 between the webs 17a and, in the radial direction, an inner and an outer region are filled with aluminum here, so as to give rise, together with the webs, to a flush surface consisting of magnetically conductive material and of electrically very highly conductive material. By means of this material mix which lies opposite the permanent magnet, because of the magnetic field of the permanent magnets, much greater eddy currents are generated in the highly conductive material 19, here aluminum, between the webs 17a than in the webs 17a themselves. In this case, however, the field routing through the webs 17a and the steel ring 17 of the magnetic field of the eddy currents in the intermediate regions 19 in a magnetically poorly conducting material is reduced to the air gap. Consequently, a markedly improved feed of the magnetic field of the eddy currents into the field of the permanent magnets can be achieved, as compared with a steel ring without webs, with the result that markedly higher torque transmission from the cooling ring 13 to the flange 10 of the fan wheel can be implemented.

With the permanent magnets remaining the same, an increase in the torque transmission by approximately the factor 3 can be achieved in the present example. However, this benefit may not only be utilized by higher torque transmission, but also by the possibility of the eddy current coupling having smaller dimensioning, along with the same torque.

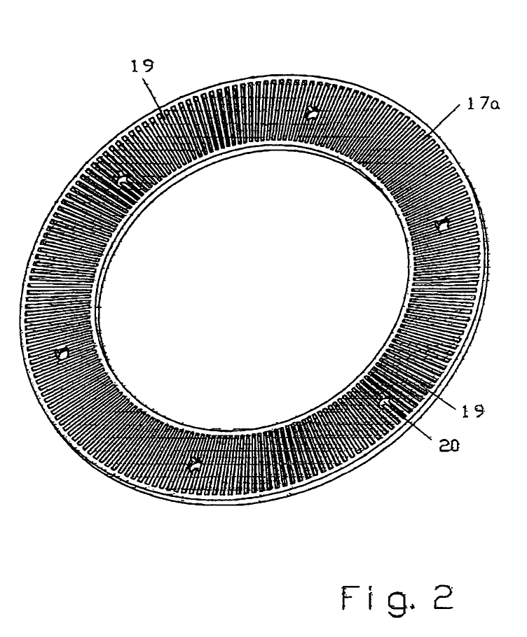

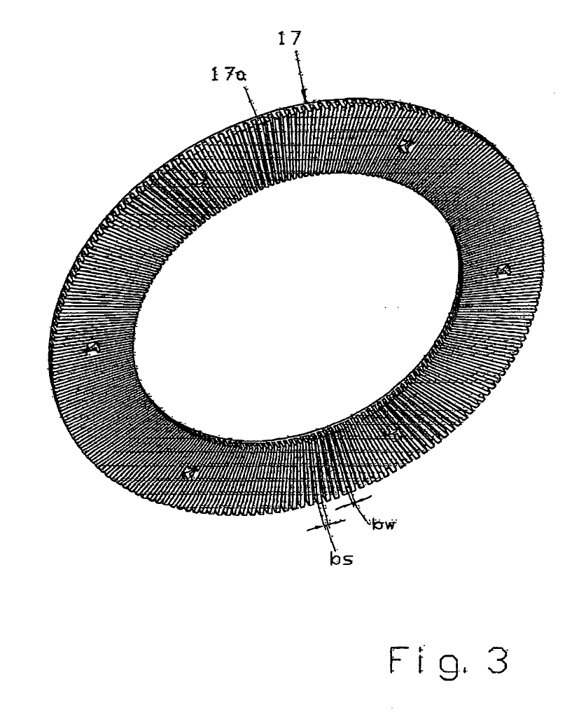

The eddy current region in the form of the steel ring 17 filled with aluminum and having webs 17a can be fixed to the cooling ring 13 in a simple way via bores 20 (see FIGS. 2 and 3) and corresponding screws.

In a preferred embodiment, the steel ring 17 with webs 17a is cast into the aluminum cooling ring 13, the web ends being flush with the remaining cooling ring surface at these points.

The steel ring 17 with webs 17a can be produced in a noncutting manner in a forming process.

The dimensioning of the width bs of the radially arranged webs in relation to the width bw of the correspondingly radially arranged regions 19 for the formation of eddy currents can be optimized in terms of a balance between maximum magnetic efficiency and the maximization of the electrical eddy currents. In the present instance, the area ratio of the radial webs 17a to the intermediate regions 19 is approximately 1:1. If appropriate, with other materials, other surface ratios may lead to a maximization of the torque transmission of the eddy current coupling 1.

List of reference symbols:

1 Fan coupling

2 Friction disk coupling

3 Friction disk coupling

4 Eddy current coupling

5 Annular armature disk

6 Annular armature disk

7 Electromagnet

8 Electromagnet

9 Stator

10 Flange

11 Ball bearing arrangement

11a Middle ring

12 Drive shaft

13 Cooling ring

14 Permanent magnet

15 Spacer ring

16 Eddy current region

17 Steel ring

17a Web

18 Air gap

19 Aluminum

20 Bore

1. An eddy current coupling (4), with a first movable coupling element (13) comprising an electrically conductive eddy current portion (16), in which eddy currents can form, and with a second coupling element (10) which is movable relative to the first coupling element (13) and on which magnets (14) are arranged in such a way that, in the event of a relative movement of the first and second coupling elements (10, 13) with respect to one another, the magnets are led past the eddy current portion (16), the first and the second coupling element (10, 13) being separated at the eddy current portion (16) via an air gap (18), and magnetic conduction means (17, 17a) consisting of magnetically conductive material being provided in the eddy current portion (16), wherein, in a plurality of first regions (17a), the area of which is not inconsiderable as compared with the eddy current portion (16), the magnetic conduction means (17, 17a) are led in the direction of the air gap (18), but, as also seen from the air gap (18), extend between the first regions (17a) in the eddy current portion (16), at points lying at a lower level, over further second regions (17).

2. The eddy current coupling as claimed in claim 1, wherein the first and the second coupling elements (10, 13) are rotatably mounted bodies, in which the eddy current portion (16) and also the magnets (14) are formed in each case in an annular region, the annular regions being located opposite one another.

3. The eddy current coupling as claimed in claim 2, wherein the first regions (17a) are elongate and extend radially.

4. The eddy current coupling as claimed in claim 2 or 3, wherein the second regions (17) are elongate and extend radially.

5. The eddy current coupling as claimed in one of the preceding claims, wherein the magnetic conduction means are led as far as the air gap (18) at least in some of the first regions (17a).

6. The eddy current coupling as claimed in one of the preceding claims, wherein the magnetic conduction means (17, 17a) comprise a sheetlike circular ring, in which elevations (17a) are arranged on a surface.

7. The eddy current coupling as claimed in one of the preceding claims, wherein the magnetic conduction means (17, 17a) are cast into the eddy current portion (16).

8. A fan coupling (1) for a fan of an internal combustion engine, with one or more electromagnetically actuable friction disk couplings (2, 3) and with an eddy current coupling (4) as claimed in one of the preceding claims.

9. A water pump coupling for a water pump of an internal combustion engine, with one or more electromagnetically actuable friction disk couplings (2, 3) and with an eddy current coupling (4) as claimed in one of the preceding claims.
